(19) United States
(12) Patent Application Publication
(10) Pub. No.: US 2011/0321005 A1
(43) Pub. Date: Dec. 29, 2011

(54) COMPACTION AND DE-ALLOCATION OF PARTIAL OBJECTS THROUGH SCHEDULING A TRANSACTION

(76) Inventor: Antonio LAIN, Menlo Park, CA (US)

(21) Appl. No.: 12/823,041

(22) Filed: Jun. 24, 2010

(51) Int. Cl. G06F 9/44

(52) U.S. Cl. 717/108; 717/122

(57) ABSTRACT

Illustrated is a system and method for identifying a current object that is part of a versioned object, the versioned object to include at least one partial object and a base object. The system and method further include marking the at least one partial object as a candidate for compaction. Additionally, the system and method include compacting the at least one partial object, where the at least one partial object is marked, by replacing a characteristic of the base object with a characteristic of the at least one partial object. The system and method includes scheduling a transaction for each thread in a transaction pool so as to de-allocate memory associated with the at least one partial object, the transaction to be executed in a non-preemptable manner.

### BACKGROUND

In software engineering, an object is a data structure that includes object attributes, and methods. Collections of objects may be used to design software applications and computer programs. These objects may be allocated or de-allocated dynamically from memory. Further, these objects, and the attributes and methods associated therewith, may be accessed using referents in the form of pointers, and handlers. Partial objects may also be generated that include modifications and extensions of the object attributes and methods. The collections of these objects (e.g., base objects) and partial objects may be organized into hierarchical data structures such as lists, trees, hash tables, or other suitable data structures. Additionally, a plurality of object may be executed in parallel as part of a thread based computing regime. In some cases, a pessimistic approach (e.g., locks or schedules) or an optimistic approach (e.g., transactions combined with multi-version concurrency control mechanisms) may be used to manage the plurality of threads used in a thread based computing regime. Either of these approaches may be used such that memory dead locks and race conditions between applications are reduced or eliminated. These approaches have a large computing overhead associated with their implementation.

The allocation or de-allocation of these objects and partial objects from memory, and the use of referents, may be managed through the use of various techniques. Reference counting is a technique use to track how many handlers are pointing to a partial object. A thread (e.g., a compaction thread) may periodically traverse the sequence of partial objects ensuring that all of them have zero counts (i.e., are not pointing to a partial object) before triggering a substitution. A substitution may be in the form of substituting the attributes of a base object for the attribute of a partial object. This substitution may occur where the partial object represents a more current state of data, than a base object that the partial object modifies. Counters that are implemented as part of reference counting may be incremented using a Compare And Swap (CAS) operations and this could also lead to a lock-free data structure. There is, however, a significant overhead associated with maintaining these reference counts since each transaction execution is likely to trigger multiple CAS operations contending for the same partial object counters. This overhead grows with the total number of handlers and that could be much larger than the total number of partial objects. In lieu of using reference counting, a garbage collection schemes like mark-and-sweep may also be adapted to solve the problem of managing the use of referents.

RCU (Read Copy Update) is a synchronization mechanism used in popular operating systems such as LINUX™ that allows concurrency between multiple readers and updaters. In particular, readers do not directly synchronize with updaters allowing very fast read path execution.

### BRIEF DESCRIPTION OF THE DRAWINGS

Some embodiments of the invention are described, by way of example, with respect to the following figures:

FIG. 1 is a diagram of a system, according to an example embodiment, illustrating nodes, in the form of compute blades, that implement the Compaction-RCU method.

FIG. 2 is a diagram of a system, according to an example embodiment, illustrating a plurality of versioned objects that make up a candidate set.

FIG. 3 is a diagram of a system 300, according to an example embodiment, illustrating the execution of a Compaction-RCU method on a versioned object.

FIG. 4 is a diagram of computer system, according to an example embodiment, that includes logic encoded as instructions on a computer readable media that, when executed by a processor associated with the computer system, implements the Compaction-RCU method.

FIG. 5 is a block diagram of a system, according to an example embodiment, used to implement the Compaction-RCU method.

FIG. 6 is a flow chart illustrating a method, according to an example embodiment, executed to implement the Compaction-RCU method.

FIG. 7 is a flow chart illustrating a method, according to an example embodiment, to execute the Compaction-RCU method.

FIG. 8 is a flow chart illustrating the execution of an operation, according to an example embodiment, to compact candidates to create a new base object that is used with the current object to create a new versioned object.

FIG. 9 is a flow chart illustrating the execution of an operation, according to an example embodiment, to schedule an empty transaction for each thread in the transactions thread pool so as to clean-up the marked partial objects.

FIG. 10 is a diagram of an example computer system.

### DETAILED DESCRIPTION

Illustrated is a system and method for using RCU to enable compaction of versioned objects. Specifically, an Compaction-RCU method is illustrated that allows for the compaction of versioned objects that include partial objects, a base object, and a reference to the most recently added partial object. Further, as part of this Compaction-RCU method, handlers used to access these partial objects and base objects are managed. This Compaction-RCU method may be separately implemented on each node of a multi-node system, where each node has one or more processors. Though the use of this Compaction-RCU method, memory dead locks and race conditions between applications can be avoided without the large computing overhead associated with the aforementioned pessimistic or optimistic approaches.

In some example embodiments, the Compaction-RCU method finds the versioned objects (VO_i) with more than one partial object in its sequence. These versioned objects make up a candidate set for compaction. A sequence, as used herein, is a data structure such as the aforementioned list, tree, or arbitrary directed acyclic graph that represent a partial order between different versions of the object. For the purpose of illustration only, a list is used as an example sequence herein. These versioned objects are candidates for compaction. For each one of the versioned objects, the most recently added partial object is identified by its pointer (i.e., *REF). A *REF, as used herein, is a referent, through the use of which, an entire sequence can be accessed. An example of a *REF includes a pointer to the head node of a list (HEAD_i), or the root node of a tree. A *REF may be a pointer of type void.

In some example embodiments, for each object VO_i in the candidate set, use a compaction function (COMPACT) that, when executed, takes the sequence of partial objects together with the old base object and returns a new, functionally equivalent, base object. The COMPACT function may start with the partial object adjacent to HEAD_i, and perform compaction on all other partial objects in the sequence. Compaction, as used herein, includes the replacing of attribute values and methods in a base object with the attribute values and methods of the partial object so as to create a new base object. Attributes and methods are collective referenced herein as characteristics. This replacement is facilitated, in part, through the use of the *REF. This compaction continues until a sequence of objects, plus the old base object, is replaced by the new base object. Where the new base object is created, the redundant partial and base objects are marked to be cleaned-up (i.e., de-allocated from memory) and the partial object that immediately precedes the redundant partial objects is modified to point to the new base object. Marking may take the form of setting a flag value within the partial object or base object.

In some example embodiments, an empty transaction is scheduled for each of the threads in the transactions thread pool using a mechanism similar to RCU. Each node upon which the Compaction-RCU method is executed has at least one thread pool. As will be discussed in more detail below, when all the empty transactions finish execution there are no handlers containing references to the marked objects. This is guaranteed by the fact that handlers are managed by the run-time system and will rebind to the current *REF at the beginning of a transaction. The execution of transactions by a thread in a thread pool is executed using non-pre-empted (i.e., atomic) scheduling. Further, all accesses to the versioned objects are within a transaction and mediated by a managed handler. When the empty transactions finish executing, the marked objects are cleaned up (i.e., de-allocated from memory).

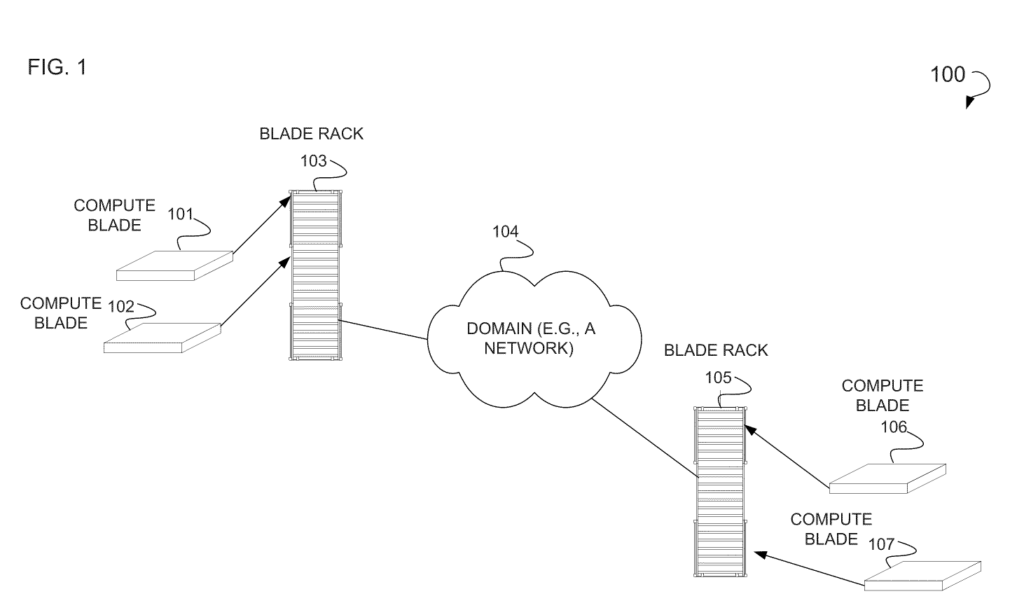

FIG. 1 is a diagram of an example system 100 illustrating nodes, in the form of compute blades, that implement the Compaction-RCU method. Shown are compute blades 101-102 that reside on a blade rack 103. Also shown are compute blades 106-107 that reside on the blade rack 105. These compute blades 101-102 and 106-107 may be operatively connected via a domain 104. Operatively connected includes a logical or physical connection. The domain 104 may be a network such as an Local Area Network (LAN), Wide Area Network (WAN), Internet, or other suitable network. As referenced herein, these compute blades 101-102 and 106-107 are nodes. A separate implementation of the Compaction-RCU method may be executed on each of the compute blades 101-102 and 106-107. The initiation of the execution of the Compaction-RCU method for each node (i.e., each of the compute blades 101-102 and 106-107) occurs at the expiration of some period of time, or at the occurrence of some event. This period of time may be predefined by a system administrator or other suitable person based upon, for example, the requirements of a Service Level Agreement (SLA). An event may be the meeting or exceeding of a memory threshold for a node based upon the allocation of memory for the partial objects of a base object. This threshold may be set by an SLA and enforced by a hypervisor, virtual machine monitor, Virtual Machine (VM), or Operating System (OS) through the use of the Compaction-RCU method.

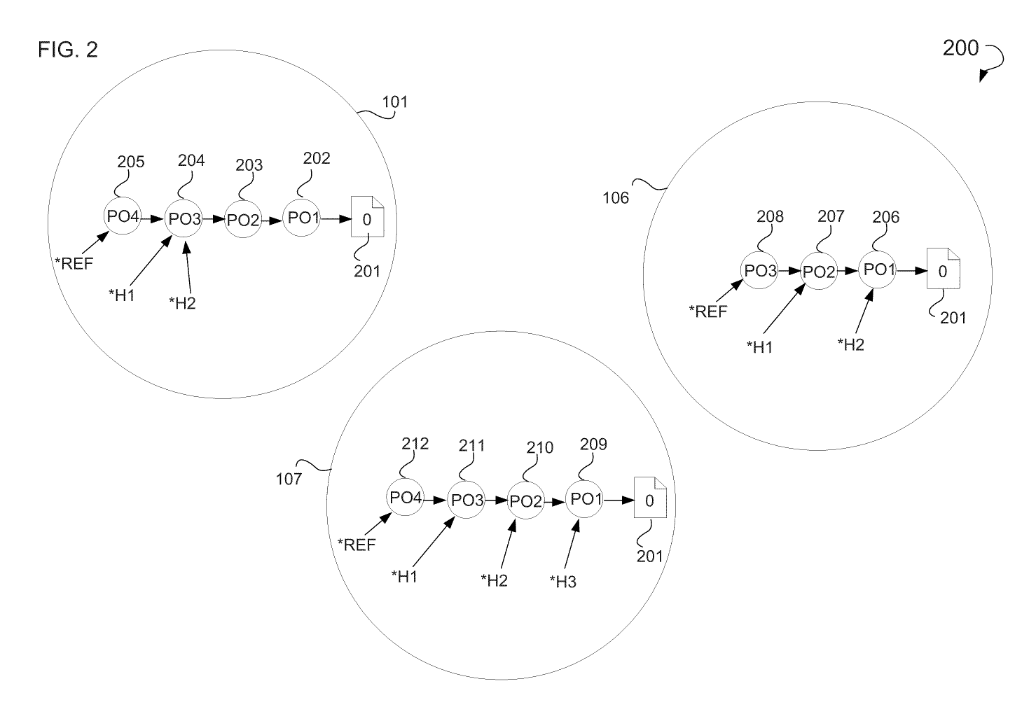

FIG. 2 is a diagram of an example system 200 illustrating a plurality of versioned objects that make up a candidate set. Shown are nodes in the form of the compute blades 101, and 106-107. Residing on the compute blade 101 is a versioned object that includes a base object 201, and partial objects 202-205. The entire versioned object may accessed via the *REF that is pointing to the partial object 205 that is serving as a head (i.e., HEAD_i) of the list that makes up the versioned object. In addition to the *REF, handlers *H1 and *H2 point to the partial object 204. Residing on the compute blade 106 is a versioned object that includes another instantiation of the base object 201. Associated with this base object 201 are partial objects 206-208. This versioned object, made up of the base object 201 and partial objects 206-208, is accessible via an additional *REF that points to the partial object 208 that is serving as a head of the list the comprises the versioned object that resides on the compute blade 106. Additional handlers *H1 and *H2 point to the partial objects 207 and 206 respectively. Residing on the compute blade 107 is a versioned object that includes a further instantiation of the base object 201, and associated partial objects 209-212. A further *REF points to the partial object 212 that serves as a head of the list that makes up this versioned object. Additionally, handlers *H1, *H2, and *H3 point to partial objects 211-209 respectively. As will be more fully illustrated below, each of these versioned objects may be a candidate for compaction based upon the occurrence of an event or the expiration of a period of time.

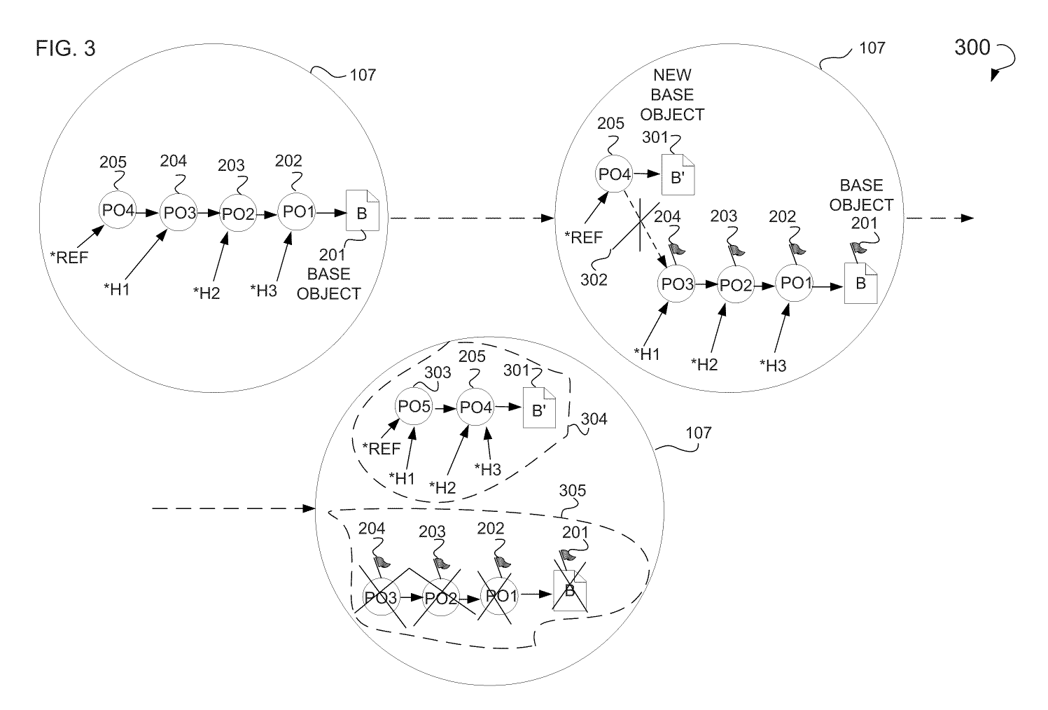

FIG. 3 is a diagram of an example system 300 illustrating the execution of a Compaction-RCU method on a versioned object. Shown are the compute blade 107 and the versioned object residing thereon. As described above, where an event occurs or a period expires, a compaction function is applied to the partial objects 204-202 and base object 201 such that a new base object B′ 301 is created. B′ 301 has the attributes and methods of the partial objects 204-202 and base object 201. During the execution of the compaction function, these partial objects 202-204, and base object 201, are also flagged for cleanup (i.e., flagged for de-allocation from memory). Further, as illustrated at 302, during the execution of the compaction function, the link between partial object 205 and the partial objects 202-204 and base object 201 is severed. B′ 301 and partial object 205 represent a new versioned object.

RCU may be applied subsequent to, or contemporaneous with, the execution of the compaction function. As illustrated at 304, where RCU is applied handlers are re-binded to the *REF and are able to access the new versioned object, and the partial objects and base objects contained therein. Here, for example, *H1 points to partial object 303, and *H2 and *H3 point to partial object 205. This re-binding is executed as part of one or more transactions by a thread in a thread pool. When executed, each transaction uses non-pre-empted scheduling such that no interleaving between threads in the pool occurs. During the application of RCU, additional partial objects may be added to the new versioned object (see e.g., partial object 303.). As shown at 305, when all the transactions finish execution there are no handlers containing references to the marked objects. These marked object are cleaned-up and de-allocated. The use of an empty transaction to mark a point in the thread pool guarantees that transactions before the empty transaction have been executed.

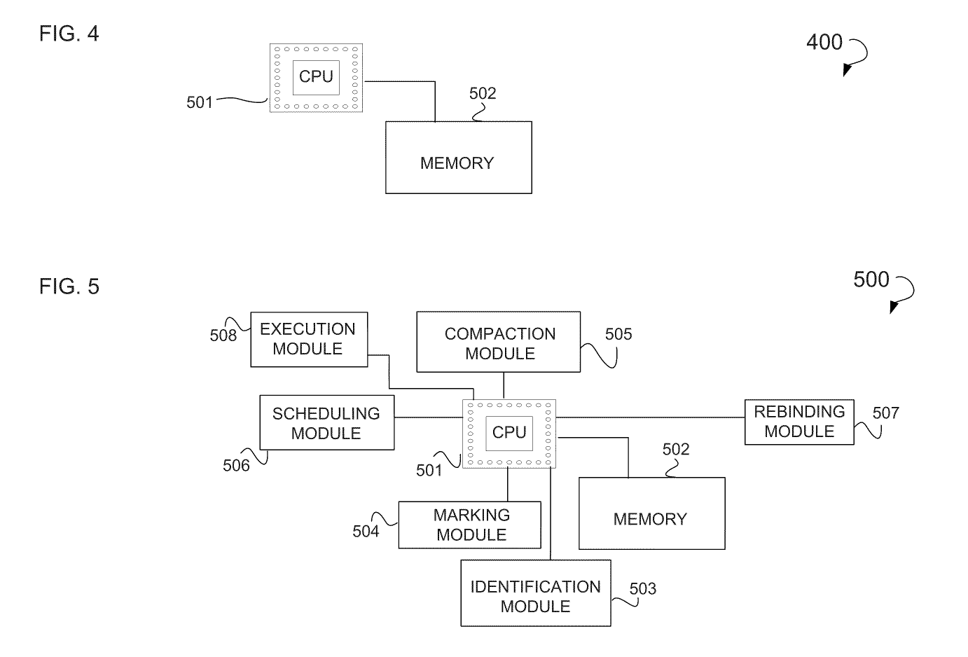

FIG. 4 is a diagram of a computer system 400 that includes logic encoded as instructions on a computer readable media that, when executed by a processor associated with the computer system 400, implements the Compaction-RCU method. An example of the computer system 400 is the compute blade 107. Shown is a Central Processing Unit (CPU) 401 operatively connected to computer readable media (or medium) 402. Instructions encoded in the logic are executed to identify a current object that is part of a versioned object, the versioned object to include at least one partial object and a base object. Additional instructions are executed to mark the at least one partial object as a candidate for compaction. Moreover, instructions are executed to compact the at least one partial object, where the at least one partial object is marked, by replacing a characteristic of the base object with a characteristic of the at least one partial object. Further, instructions are executed to schedule a transaction for each thread in a transaction pool so as to de-allocate memory associated with the at least one partial object, the transaction to be executed in a non-preemptable manner. In some example embodiments, the transaction is an empty transaction that marks a point in a thread pool before which all previous transactions being executed have finished. These previous transactions to include all in-flight transactions, transactions to be executed during the compaction process. The empty transaction may alternatively be a transaction where each thread in the thread pool executes, and guarantees after their termination that any other transactions that started execution before the empty transaction have completed (or restarted). The instructions are further executed to add an additional partial object to the versioned object and to bind a referent to the additional partial object. In some example embodiments, the versioned object is at least one of a list, tree, or a directed acyclic graph that represents a partial order between the at least one partial object and another partial object. In some example embodiments, the current object is an additional partial object. Instructions may be executed to initiate the execution of the -RCU method based upon at least one of an event, or an expiration of a period. In some example embodiments, the compacting and scheduling are executed in parallel.

FIG. 5 is a block diagram of a system 500 used to implement the Compaction-RCU method. The blocks may be implemented in hardware, firmware, or software. These blocks may be operatively connected via a logical or physical connection. An example of the system 500 is the compute blade 107. Show is a CPU 501 operatively connected to a memory 502. Operatively connected to the CPU 501 is an identification module 503 to identify a current object that is part of a versioned object, the versioned object to include at least one partial object and a base object. Operatively connected to the CPU 501 is a marking module 504 to mark the at least one partial object as a candidate for compaction. Operatively connected to the CPU 501 is a compaction module 505 to compact the at least one partial object, where the at least one partial object is marked, by replacing a characteristic of the base object with a characteristic of the at least one partial object. Operatively connected to the CPU 501 is a scheduling module 506 to schedule a transaction for each thread in a transaction pool so as to de-allocate memory associated with the at least one partial object, the transaction to be executed in a non-preemptable manner. Operatively connected to the CPU 501 is a rebinding module 507 to re-bind at least one handler, that refers to the at least one partial object, to the current object during the execution of the transaction. In some example embodiments, the versioned object is at least one of a list, tree, or a directed acyclic graph that represents a partial order between the at least one partial object and another partial object. In some example embodiments, the current object is an additional partial object. Operatively connected to the CPU 501 is an execution module 508 to initiate execution based upon at least one of an event, or an expiration of a period. In some example embodiments, the compacting and scheduling are executed in parallel.

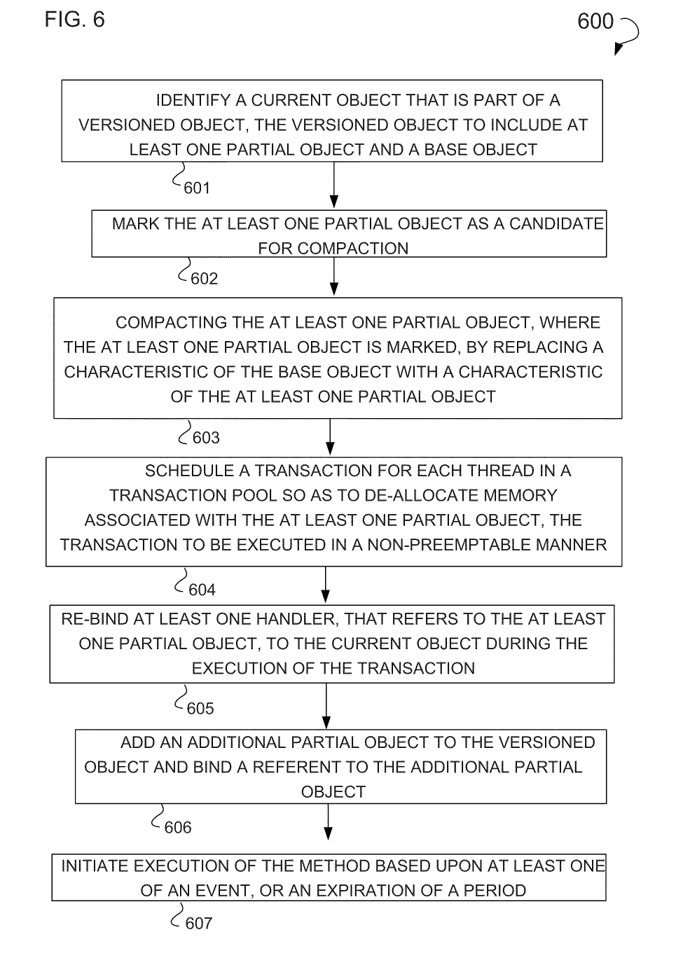

FIG. 6 is a flow chart illustrating an example method 600 executed to implements the Compaction-RCU method. This method 600 may be executed on the compute blade 107. Illustrated is an operation 601 that is executed by the identification module 503 to identify a current object that is part of a versioned object, the versioned object to include at least one partial object and a base object. Operation 602 is executed by the marking module 504 to mark the at least one partial object as a candidate for compaction. Operation 603 is executed by the compaction module 505 to compact the at least one partial object, where the at least one partial object is marked, by replacing a characteristic of the base object with a characteristic of the at least one partial object. Operation 604 is executed by the scheduling module 506 to schedule a transaction for each thread in a transaction pool so as to de-allocate memory associated with the at least one partial object, the transaction to be executed in a non-preemptable manner. Operation 605 is executed by a rebinding module 507 to re-bind at least one handler, that refers to the at least one partial object, to the current object during the execution of the transaction. In some example embodiments, no handlers are re-bound as RCU guarantees that there are no handlers pointing to old base objects or partial objects. Operation 606 is executed by the CPU 501 to add an additional partial object to the versioned object, and to bind a referent to the additional partial object. This operation 606 may be optional. In some example embodiments, the versioned object is at least one of a list, tree, or a directed acyclic graph representing a partial order between the at least one partial object and another partial object. In some example embodiments, the current object is an additional partial object. Operation 607 is executed by the execution module 508 to initiate execution of the method based upon at least one of an event, or an expiration of a period. In some example embodiments, the compacting and scheduling are executed in parallel.

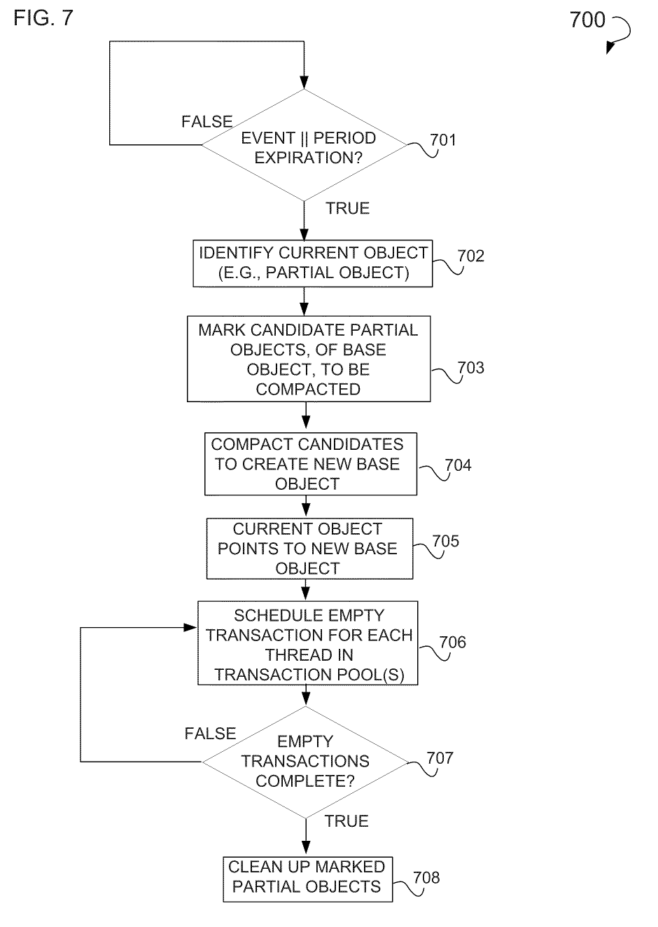

FIG. 7 is a flow chart illustrating an example method 700 to execute the Compaction-RCU method. This method 700 may be executed on the compute blade 107 or other suitable node. The various operations in this method may be executed in parallel, rather than sequentially as is illustrated. Shown is a decision operation 701 that is executed to determine whether an event has occurred or whether a period has expired. As previously discussed, an event may be the meeting or exceeding of a memory threshold value relating the amount of memory that may be used by a versioned object. The time period may dictated by an SLA. In cases where the decision operation 701 evaluates to “false,” the decision operation 901 is re-executed. In cases where the decision operation 701 evaluates to “true,” an operation 702 is executed. Operation 702, when executed, identifies an object, such as a partial object, as the current object. A *REF may be used to identify the current object. An example of a current object is the partial object 205 in FIG. 3. Partial objects before this current object (e.g., partial objects 202-204 in FIG. 3) are candidates for compaction, while partial objects after this partial object are not candidates for compaction. Operation 703 is executed to mark candidate partial objects to be compacted. Partial objects 202-204 in FIG. 3 are examples of these marked partial objects. Operation 704 is executed to compact candidates to create a new base object that is used with the current object to create a new versioned object. B′ 301 is an example of a new base object. The execution of operation 704 is illustrated in more detail below. Operation 705 is executed to point a reference from the current objection to the new base object. This is illustrated in FIG. 3 where the partial object 205 points to B′ 301. Operation 706 is executed to schedule an empty transaction for each thread in the transactions thread pool so as to clean-up (i.e., de-allocate the memory) the marked partial objects. It is guaranteed that by the time all these empty transactions finish there are no handlers that refer to marked candidate partial objects. This operation is executed like any other transaction (i.e., in a non-preemptable scheduled manner) so that its execution cannot interleave with other transactions allocated to the same thread for a versioned object that is being compacted. The execution of operation 705 is illustrated in more detail below. Decision operation 707 is executed to determine whether the empty transaction(s) have completed. In cases where decision operation 707 evaluates to “false,” the operation 706 is re-executed. In cases where decision operation 707 evaluates to “true,” an operation 708 is executed. Operation 708 is executed to clean up the marked partial objects.

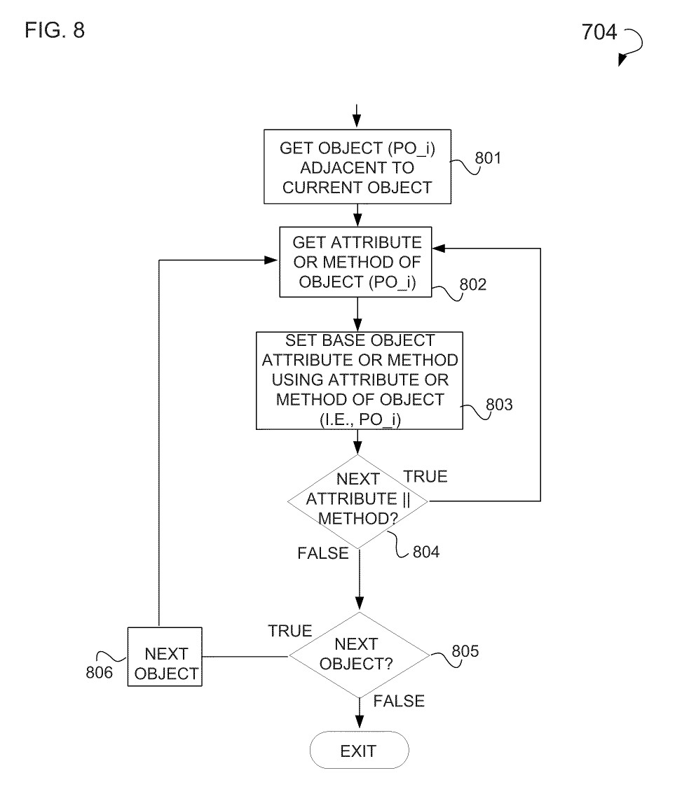

FIG. 8 is a flow chart illustrating the example execution of operation 704 to compact candidates to create a new base object that is used with the current object to create a new versioned object. Shown is an operation 801 that is executed to get an object adjacent (i.e., the adjacent object) to the current object. Get includes to identify, or to otherwise access. Operation 802 is executed to get an attribute or a method associated with the adjacent object. Operation 803 is executed to set a base object attribute or method using the attribute or method associated the adjacent object. The attribute or method of the adjacent object may be common to both the base object and the adjacent object, or a new attribute or method. Decision operation 804 is executed to determine whether an additional (next) attribute or method exists for the adjacent object. In cases where decision operation 804 evaluates to “true,” the operation 802 is re-executed. In cases where the decision operation 804 evaluates to “false,” a decision operation 805 is executed. Decision operation 805 determines whether additional partial objects exist as part of the versioned object. In cases where the decision operation 805 evaluates to “true,” an operation 806 is executed to get the next partial object in the versioned object that is to be compacted. In cases where decision operation 805 evaluates to “false,” a termination condition is executed.

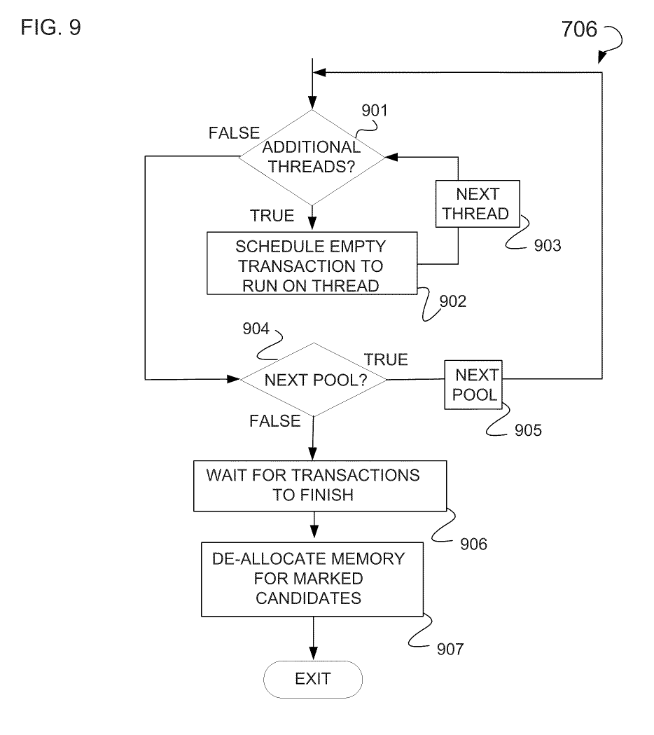

FIG. 9 is a flow chart illustrating the example execution of operation 706 to schedule an empty transaction for each thread in the transactions thread pools so as to clean-up the marked partial objects. Decision operation 901 is executed to determine whether additional threads in a thread pool exist. In cases where decision operation 901 evaluates to “true,” operation 902 is executed. In cases where decision operation 901 evaluates to “false,” decision operation 904 is executed. Operation 902 schedules an empty transaction to run on a thread in the thread pool. Operation 903 is executed to iterate to the next thread in the thread pool. Decision operation 904 is executed to determine whether an additional thread pool exists. In cases where decision operation 904 evaluates to “true,” an operation 905 is executed to iterate to the next thread pool. In cases where decision operation 904 evaluates to “false,” an operation 906 is executed. Operation 906 is executed to wait for transactions in a thread pool to finish. In some example embodiments, this might be all transactions in all thread pools, where an empty transaction has been scheduled. Operation 907 is executed to de-allocate memory for marked candidates. In some example embodiments, this might be a de-allocation for all marked candidates. A termination condition is executed.

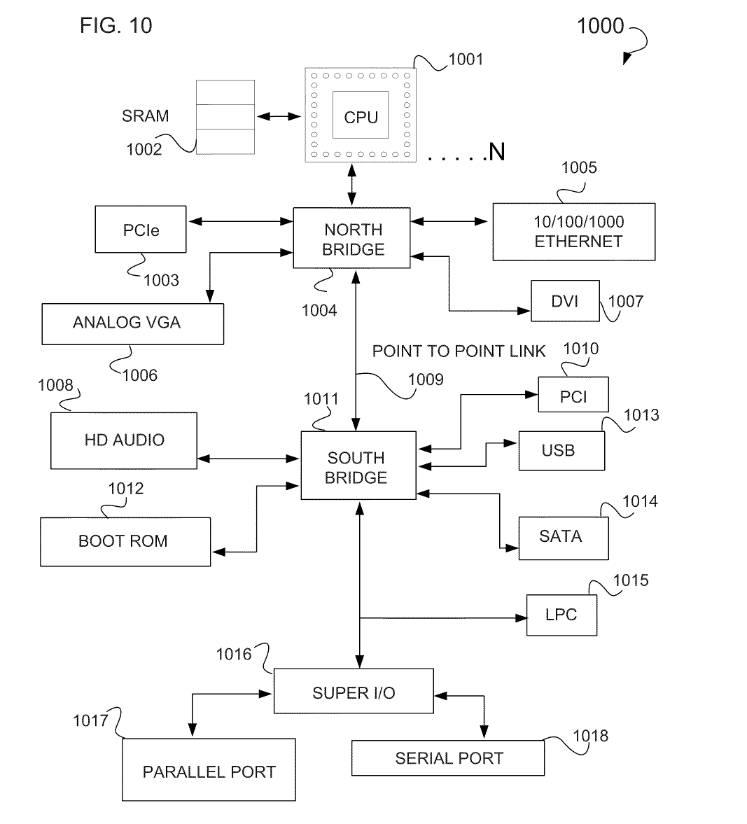

FIG. 10 is a diagram of an example computer system 1000. Shown is a CPU 1001. The processor die 201 may be a CPU 1001. In some example embodiments, a plurality of CPU may be implemented on the computer system 1000 in the form of a plurality of core (e.g., a multi-core computer system), or in some other suitable configuration. Some example CPUs include the x86 series CPU. Operatively connected to the CPU 1001 is Static Random Access Memory (SRAM) 1002. Operatively connected includes a physical or logical connection such as, for example, a point to point connection, an optical connection, a bus connection or some other suitable connection. A North Bridge 1004 is shown, also known as a Memory Controller Hub (MCH), or an Integrated Memory Controller (IMC), that handles communication between the CPU and PCIe, Dynamic Random Access Memory (DRAM), and the South Bridge. An ethernet port 1005 is shown that is operatively connected to the North Bridge 1004. A Digital Visual Interface (DVI) port 1007 is shown that is operatively connected to the North Bridge 1004. Additionally, an analog Video Graphics Array (VGA) port 1006 is shown that is operatively connected to the North Bridge 1004. Connecting the North Bridge 1004 and the South Bridge 1011 is a point to point link 1009. In some example embodiments, the point to point link 1009 is replaced with one of the above referenced physical or logical connections. A South Bridge 1011, also known as an I/O Controller Hub (ICH) or a Platform Controller Hub (PCH), is also illustrated. A PCIe port 1003 is shown that provides a computer expansion port for connection to graphics cards and associated GPUs. Operatively connected to the South Bridge 1011 are a High Definition (HD) audio port 1008, boot RAM port 1012, PCI port 1010, Universal Serial Bus (USB) port 1013, a port for a Serial Advanced Technology Attachment (SATA) 1014, and a port for a Low Pin Count (LPC) bus 1015. Operatively connected to the South Bridge 1011 is a Super Input/Output (I/O) controller 1016 to provide an interface for low-bandwidth devices (e.g., keyboard, mouse, serial ports, parallel ports, disk controllers). Operatively connected to the Super I/O controller 1016 is a parallel port 1017, and a serial port 1018.

The SATA port 1014 may interface with a persistent storage medium (e.g., an optical storage devices, or magnetic storage device) that includes a machine-readable medium on which is stored one or more sets of instructions and data structures (e.g., software) embodying or utilized by any one or more of the methodologies or functions illustrated herein. The software may also reside, completely or at least partially, within the SRAM 1002 and/or within the CPU 1001 during execution thereof by the computer system 1000. The instructions may further be transmitted or received over the 10/100/1000 ethernet port 1005, USB port 1013 or some other suitable port illustrated herein.

In some example embodiments, a removable physical storage medium is shown to be a single medium, and the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

In some example embodiments, the methods illustrated herein are implemented as one or more computer-readable or computer-usable storage media or mediums. The storage media include different forms of memory including semiconductor memory devices such as DRAM, Phase Change RAM (PCRAM), Memristor, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. A computer implemented method comprising:
identifying a current object that is part of a versioned object, the versioned object to include at least one partial object and a base object;
marking the at least one partial object as a candidate for compaction;
compacting the at least one partial object, where the at least one partial object is marked, by replacing a characteristic of the base object with a characteristic of the at least one partial object; and
scheduling a transaction for each thread in a transaction pool so as to de-allocate memory associated with the at least one partial object, the transaction to be executed in a non-preemptable manner.

2. The computer implemented method of claim 1, further comprising re-binding at least one handler, that refers to the at least one partial object, to the current object during the execution of the transaction.

3. The computer implemented method of claim 1, further comprising:
adding an additional partial object to the versioned object; and
binding a referent to the additional partial object.

4. The computer implemented method of claim 1, wherein the versioned object is at least one of a list, tree, or a directed acyclic graph representing a partial order between the at least one partial object and another partial object.

5. The computer implemented method of claim 1, wherein the current object is an additional partial object.

6. The computer implemented method of claim 1, further comprising initiating execution of the method based upon at least one of an event, or an expiration of a period.

7. The computer implemented method of claim 1, wherein the compacting and scheduling are executed in parallel.

8. A computer system comprising:
at least one processor;
a memory in communication with the at least one processor, the memory including logic encoded in one or more tangible media for execution and when executed operable to:
identify a current object that is part of a versioned object, the versioned object to include at least one partial object and a base object;
mark the at least one partial object as a candidate for compaction;
compact the at least one partial object, where the at least one partial object is marked, by replacing a characteristic of the base object with a characteristic of the at least one partial object; and
schedule a transaction for each thread in a transaction pool so as to de-allocate memory associated with the at least one partial object, the transaction to be executed in a non-preemptable manner.

9. The computer system of claim 8, wherein the transaction is an empty transaction that marks a point in a thread pool before which all previous transactions being executed have finished.

10. The computer system of claim 8, further comprising logic encoded in one or more tangible media for execution and when executed operable to:
add an additional partial object to the versioned object; and
bind a referent to the additional partial object.

11. The computer system of claim 8, wherein the versioned object is at least one of a list, tree, or a directed acyclic graph that represents a partial order between the at least one partial object and another partial object.

12. The computer system of claim 8, wherein the current object is an additional partial object.

13. The computer system of claim 8, further comprising logic encoded in one or more tangible media for execution and when executed operable to initiate execution based upon at least one of an event, or an expiration of a period.

14. The computer system of claim 8, wherein the compacting and scheduling are executed in parallel.

15. An apparatus comprising:
an identification module to identify a current object that is part of a versioned object, the versioned object to include at least one partial object and a base object;
a marking module to mark the at least one partial object as a candidate for compaction;
a compaction module to compact the at least one partial object, where the at least one partial object is marked, by replacing a characteristic of the base object with a characteristic of the at least one partial object; and
a scheduling module to schedule a transaction for each thread in a transaction pool so as to de-allocate memory associated with the at least one partial object, the transaction to be executed in a non-preemptable manner.

16. The apparatus of claim 15, further comprising a rebinding module to re-bind at least one handler, that refers to the at least one partial object, to the current object during the execution of the transaction.

17. The apparatus of claim 15, wherein the versioned object is at least one of a list, tree, or a directed acyclic graph that represents a partial order between the at least one partial object and another partial object.

18. The apparatus of claim 15, wherein the current object is an additional partial object.

19. The apparatus of claim 15, further comprising an execution module to initiate execution based upon at least one of an event, or an expiration of a period.

20. The apparatus of claim 15, wherein the compacting and scheduling are executed in parallel.
